(19) United States
(12) Patent Application Publication
(10) Pub. No.: US 2016/0198674 A1
(43) Pub. Date: Jul. 14, 2016

(54) ELEVATED PET BED DEVICE

(71) Applicants: Mark Younger, Upper Falls, MD (US); Barbara Younger, Upper Falls, MD (US)

(72) Inventors: Mark Younger, Upper Falls, MD (US); Barbara Younger, Upper Falls, MD (US)

(21) Appl. No.: 14/592,912

(22) Filed: Jan. 9, 2015

(51) Int. Cl. A01K 1/035; A01K 29/00

(52) U.S. Cl. CPC A01K 1/0353; A01K 29/00

(57) ABSTRACT

An elevated pet bed device elevates a pet bed level with an existing mattress to allow a pet to sleep adjacent to an owner without taking space on the owner's mattress. The device includes a frame having a base section and a top section. The top section is extendable away from the base section. A pet bed is positionable on the top section of the frame wherein the frame is configured for supporting the pet bed in an elevated position over a support surface upon which the base section rests.

### BACKGROUND OF THE DISCLOSURE

### Field of the Disclosure

The disclosure relates to pet bed devices and more particularly pertains to a new pet bed device for elevating a pet bed level with an existing mattress to allow a pet to sleep adjacent to an owner without taking space on the owner's mattress.

SUMMARY OF THE DISCLOSURE

An embodiment of the disclosure meets the needs presented above by generally comprising a frame having a base section and a top section. The top section is extendable away from the base section. A pet bed is positionable on the top section of the frame wherein the frame is configured for supporting the pet bed in an elevated position over a support surface upon which the base section rests.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an elevated pet bed device according to an embodiment of the disclosure.

FIG. 2 is a partially exploded top front side perspective view of an embodiment of the disclosure.

FIG. 3 is a back view of an embodiment of the disclosure.

FIG. 4 is a side view of an embodiment of the disclosure.

FIG. 5 is a side view of an embodiment of the disclosure in a collapsed position.

FIG. 6 is a top front side perspective view of an embodiment of the disclosure positioned for use.

FIG. 7 is a top view of an embodiment of the disclosure in use.

### DESCRIPTION OF THE PREFERRED EMBODIMENT

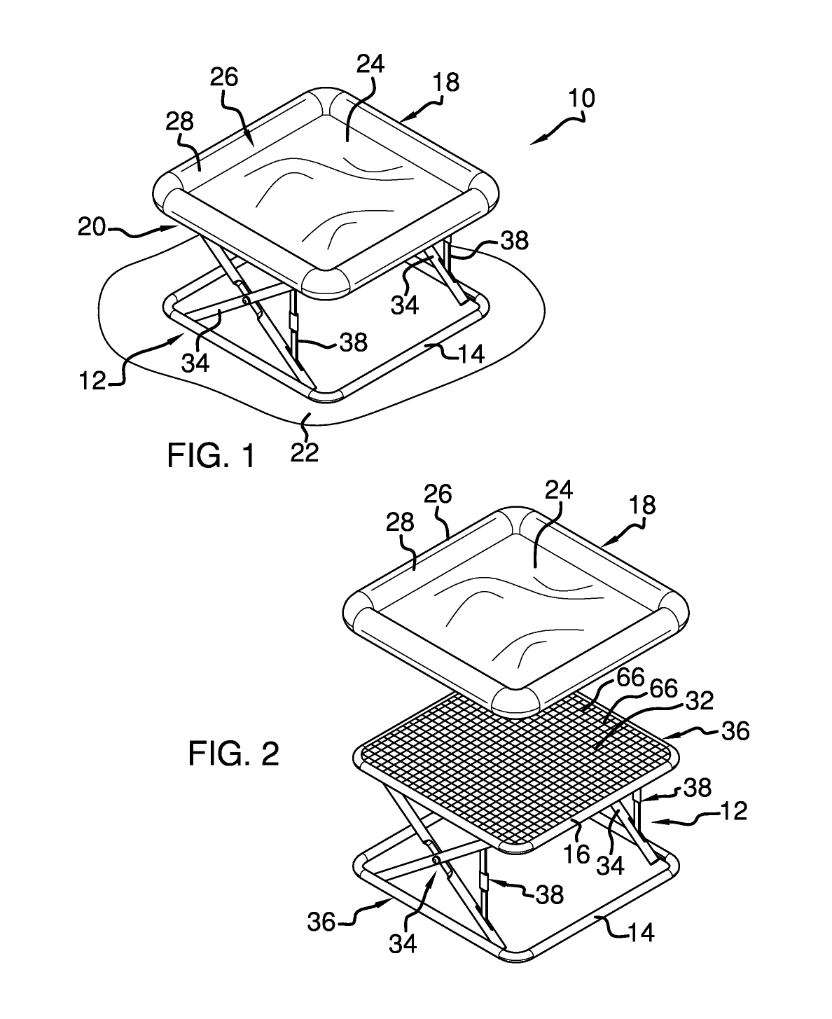

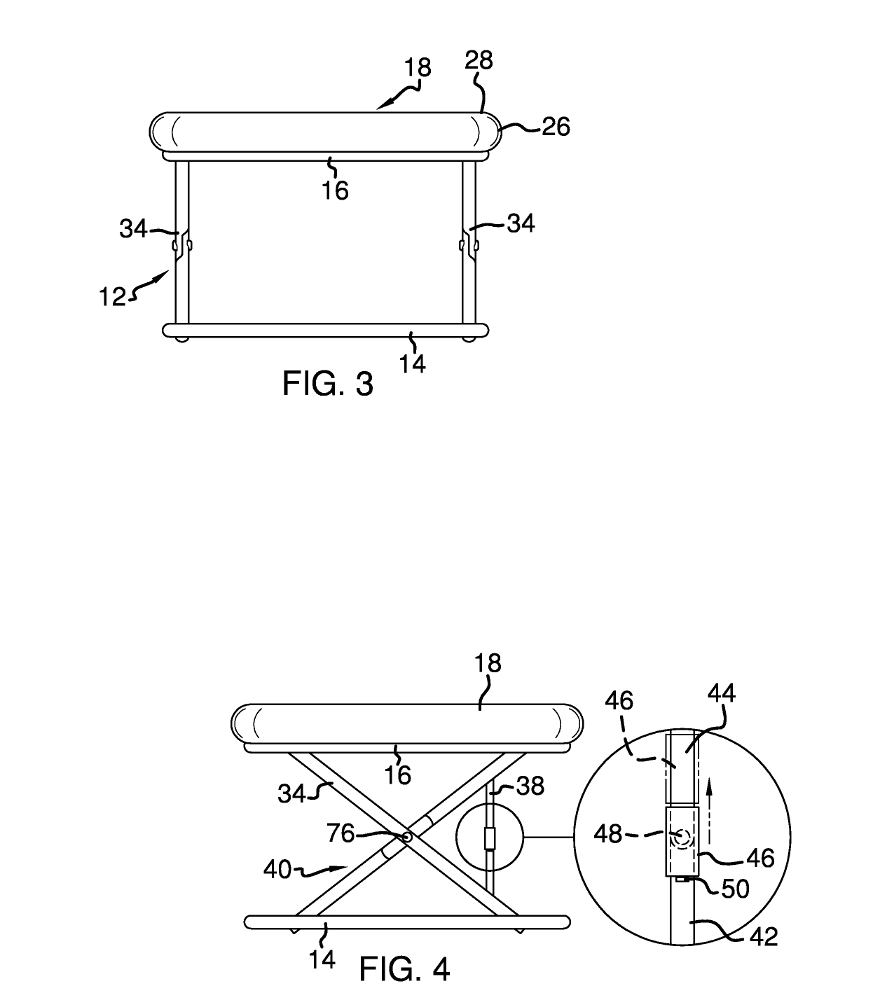

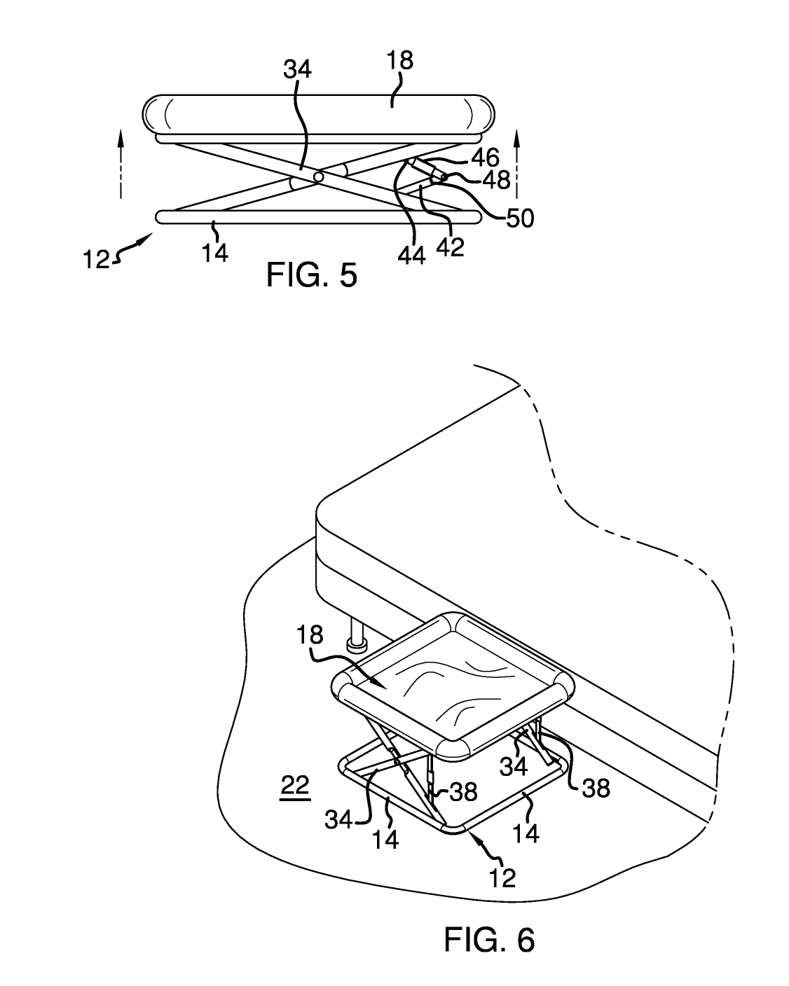

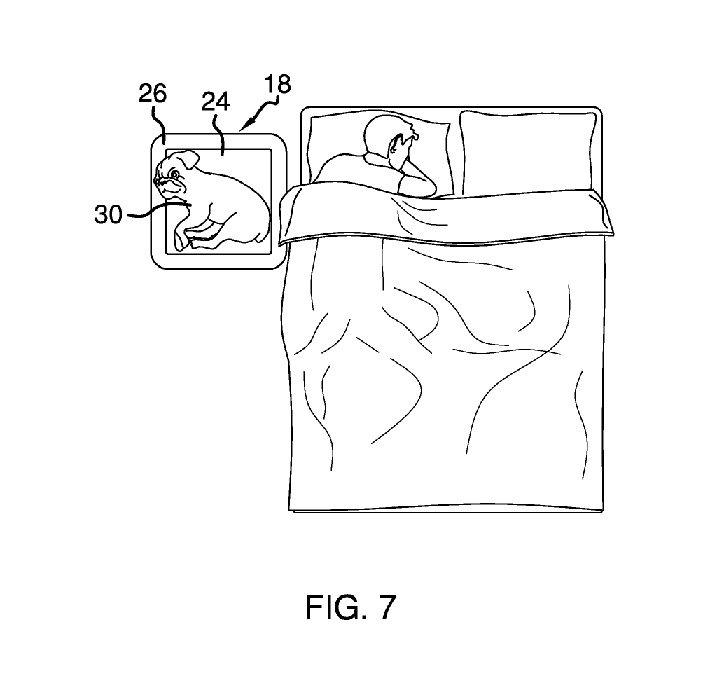

With reference now to the drawings, and in particular to FIGS. 1 through 7 thereof, a new pet bed device embodying the principles and concepts of an embodiment of the disclosure and generally designated by the reference numeral 10 will be described.

As best illustrated in FIGS. 1 through 7, the elevated pet bed device 10 generally comprises a frame 12 having a base section 14 and a top section 16. The top section 16 is extendable away from the base section 14. The base section 14 is parallel to the top section 16 and remains parallel to the top section 16 as the top section 16 is moved relative to the bottom section 14. Each of the base section 14 and the top section 16 of the frame 12 is square and may be constructed of metal tubing or the like.

A pet bed 18 is positionable on the top section 16 of the frame 12 wherein the frame 12 is configured for supporting the pet bed 18 in an elevated position 20 over a support surface 22 upon which the base section 14 rests. The pet bed 18 has a central section 24 and a peripheral section 26 coupled to and extending around the central section 24. The peripheral section 26 defines a lip 28 extending upwardly and around the central section 24 wherein the peripheral section 26 is configured for inhibiting a pet 30 from rolling off of the central section 24 over the peripheral section 26. Netting 32 is coupled to the top section 16 of the frame 12 such that the netting 32 extends across the frame 12 to support the pet bed 18 on the frame 12. The netting 32 may be constructed of nylon, cotton, or the like. The netting 32 forms a grid with openings 66 to promote air flow around the pet bed 18 during use.

Each of a pair of scissor arms 34 is coupled to an associated side 36 of the frame 12 and extends between the base section 14 and the top section 16. Each of a pair of braces 38 is coupled to an associated one of the scissor arms 34. Each brace 38 holds the associated scissor arm 34 in an extended position 40. Each brace 38 comprises a bottom portion 42 pivotally coupled to a top portion 44. Each brace 38 further comprises a sleeve 46 slidable over a pivot point 48 between the bottom portion 42 and the top portion 44 wherein the sleeve 46 inhibits pivoting of the top portion 44 relative to the bottom portion 42. Each brace 38 further includes a projection 50 coupled to and extending from the bottom portion 42 of the brace 38. The projection 50 supports the sleeve 46 in a position covering the pivot point 48 wherein the top portion 44 is inhibited from pivoting relative to the bottom portion 42 when the sleeve 46 rests on the projection 50. The pivot point 48 of each brace 38 is horizontally aligned with a pivot point 76 of the associated scissor arm 34.

In use, the top section 16 of the frame 12 is elevated relative to the base section 14 resulting in the linear alignment of the respective top portions 44 and bottom portions 42 of the braces 38. The alignment of the braces 38 allows the sleeves 46 to cover the respective pivot points 48 preventing the scissor arms 34 from collapsing. The pet bed 18 is then supported in the elevated position 20 until the frame 12 is collapsable by lifting the sleeves 46 allowing the braces 38 to bend at the pivot points 48. The device 10 may be stored under a bed until ready for use. In the elevated position 20, the pet bed 18 is positioned adjacent to and substantially level with a mattress allowing a pet on the bed to sleep near an owner without taking up room on the mattress.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An elevated pet bed device comprising:
a frame having a base section and a top section, said top section being extendable away from said base section; and
a pet bed positionable on said top section of said frame wherein said frame is configured for supporting said pet bed in an elevated position over a support surface upon which said base section rests.

2. The device of claim 1, further comprising said base section being parallel to said top section.

3. The device of claim 2, further comprising said base section remaining parallel to said top section as said top section is moved relative to said bottom section.

4. The device of claim 1, further comprising a pair of scissor arms, each of said scissor arms being coupled to an associated side of said frame and extending between said base section and said top section.

5. The device of claim 4, further comprising a pair of braces, each said brace being coupled to an associated one of said scissor arms, each said brace holding said associated scissor arm in an extended position.

6. The device of claim 5, further comprising each said brace comprising a bottom portion pivotally coupled to a top portion, each said brace further comprising a sleeve slidable over a pivot point between said bottom portion and said top portion wherein said sleeve inhibits pivoting of said top portion relative to said bottom portion.

7. The device of claim 6, further comprising each said brace comprising a projection coupled to and extending from said bottom portion of said brace, said projection supporting said sleeve in a position covering said pivot point wherein said top portion is inhibited from pivoting relative to said bottom portion when said sleeve rests on said projection.

8. The device of claim 1, further comprising each of said base section and said top section of said frame being square.

9. The device of claim 1, further comprising said pet bed having a central section and a peripheral section coupled to and extending around said central section, said peripheral section defining a lip extending upwardly and around said central section wherein said peripheral section is configured for inhibiting a pet from rolling off of said central section over said peripheral section.

10. The device of claim 1, further comprising netting coupled to said top section of said frame such that said netting extends across said frame to support said pet bed on said frame.

11. An elevated pet bed device comprising:
a frame having a base section and a top section, said top section being extendable away from said base section, said base section being parallel to said top section, said base section remaining parallel to said top section as said top section is moved relative to said bottom section, each of said base section and said top section of said frame being square;
a pet bed positionable on said top section of said frame wherein said frame is configured for supporting said pet bed in an elevated position over a support surface upon which said base section rests, said pet bed having a central section and a peripheral section coupled to and extending around said central section, said peripheral section defining a lip extending upwardly and around said central section wherein said peripheral section is configured for inhibiting a pet from rolling off of said central section over said peripheral section;
netting coupled to said top section of said frame such that said netting extends across said frame to support said pet bed on said frame;
a pair of scissor arms, each of said scissor arms being coupled to an associated side of said frame and extending between said base section and said top section;
a pair of braces, each said brace being coupled to an associated one of said scissor arms, each said brace holding said associated scissor arm in an extended position, each said brace comprising a bottom portion pivotally coupled to a top portion, each said brace further comprising a sleeve slidable over a pivot point between said bottom portion and said top portion wherein said sleeve inhibits pivoting of said top portion relative to said bottom portion, each said brace comprising a projection coupled to and extending from said bottom portion of said brace, said projection supporting said sleeve in a position covering said pivot point wherein said top portion is inhibited from pivoting relative to said bottom portion when said sleeve rests on said projection.
